(19) United States
(12) Patent Application Publication
(10) Pub. No.: US 2020/0285768 A1
(43) Pub. Date: Sep. 10, 2020

(54) METHOD FOR DETERMINING AND DISPLAYING THE SECURITY STATE OF DATA

(71) Applicant: WOCASH LLC, Miami, FL (US)

(72) Inventor: Steve A. Hodges, SR., Miami, FL (US)

(21) Appl. No.: 16/809,890

(22) Filed: Mar. 5, 2020

Related U.S. Application Data
(60) Provisional application No. 62/815,296, filed on Mar. 7, 2019.

(51) Int. Cl. G06F 21/62; G06F 21/60; G06Q 50/26; G06Q 30/00

(52) U.S. Cl. CPC G06F 21/6245; G06Q 30/018; G06Q 50/265; G06F 21/604

(57) ABSTRACT

A method for determining and displaying the security state of data is disclosed where a third party operates a database having a computer storage medium for storage of non-transitory data. A first party stores data on the third party database. A website interface is established by the first party to access the data over the Internet. A user is allowed access to the data stored on the third party database through the website interface. A set of validation rules are configured to be applied to the data. Compliance or non-compliance with a set of validation rules determines a security state of the data. The security state of the data is determined based upon the compliance of the data with the set of validation rules. An indicator representative of the security state of the data is sent to the website interface of the first party and displayed to the user.

### CROSS-REFERENCE TO RELATED APPLICATIONS

This non-provisional application claims priority to provisional application 62/815,296 filed on Mar. 7, 2019, the entire contents of which are fully incorporated herein with these references.

### DESCRIPTION

### Field of the Invention

The field of the invention is a method of informing users when entering a website via a visual indicator as to the safety of the stored information by the company operating the website. This is to ensure that the user is being notified in near real-time when there is a possibility that their data may have been compromised. The user can then take measures to protect themselves from possible exposure. There is not a single system on the market today that reports to the public in near real-time and holds the company responsible for reporting when and why a security breach happens by a third-party company.

### Background of the Invention

Today's technologies use different methods for data storage that can be modified by a user, customer service, programmers and/or database administrators. This creates possibility for the abuse of power. It allows people to make unauthorized changes and to create data dumps of customer information all while having no way of knowing exactly what was lost. In these situations, the company usually has a discussion to make as to when, if ever, they will notify the customer of the breach and what information they will provide.

There are currently other solutions that ensure basic setup to comply with PCI (Protecting Payment Card Information), SOC 1/SOC 2/SSAE 16/SSAE 18, and SOX reporting to see if the systems have controls in place, and are self-governed. G06Q addresses the third-party interaction during a payment transaction, and does not serve any other purpose after the transaction has been completed. They do not provide for any real-time reporting to the public or third-party auditors, or as a method of saying, “you are in a tamper free data zone”. G06Q 20/02 involving certification authority, notary or trusted third party (TTP).

Accordingly, there is a need for a better system of reporting to the public when information has been modified or lost by unauthorized parties. The involvement of a neutral third party is an essential aspect of the process. This will hold the company responsible for the actions that were identified while implementing corrective measures to identify the issue. These are similar measures that the financial industry takes when filing a Suspicious Activity Report (SAR) to the federal government with a single difference; the government does not report to the public when a SAR happens. During the period before the company has cleared the report to the third party, their website status will go from “green” to a “red or yellow” indicator. This is much like a website shows a closed lock when secure and a lock with a line through it when it is not which is governed by a third-party provider. Attention is drawn to the following places for informative references which may be of interest for search, such as insuring higher security of transaction involving key management G06Q 20/3829. Security arrangements for protecting computers or computer systems against unauthorized activity G06F 21/00. Arrangements for secure communication H04L 9/00 Special rules of classification. The best fit priority rule applies: the most pertinent subgroup should be used for classification. Head group applies only if no subgroup applies. In case the third party manages the encryption keys, both the present class and G06Q 20/3829 should be allocated.

### SUMMARY OF THE INVENTION

The “Tamper Free Data Zone” of the present invention is designed to have a public facing indicator that shows the status of the information evaluated by a neutral third party. The system will be governed by a series of rules based on industry requirements and added strength to ensure higher levels of security reporting. When a company fails to comply with the standards, the indicator will change to show that the website may not be in compliant and that company data is at risk.

Corporations around the world are failing to report to the public when data breaches occur. One example is the case of the company Capital One reported by the New York Times on Jul. 29, 2019: “In a breach in 2017, Capital One notified customers that a former employee may have had access for nearly four months to their personal data, including account numbers, telephone numbers, transaction history and Social Security numbers. The company reported a similar breach involving an employee in 2014.” This type of system of the present invention was in place it would have been reported both to management by the third party and the public every time someone went to the website.

Other times, corporations can share your information without authorization. One example is Facebook reported by USA Today on Jul. 24, 2019: “Facebook's record $5 billion fine, part of its settlement with the Federal Trade Commission announced Wednesday, will require the social network to adopt stricter privacy and security measures. The FTC's action stems from the 2018 Cambridge Analytica scandal, in which as many as 50 million Facebook users' data was misused.” Again, if the present invention was in place it could have alerted not only the company of the misuse of data but would have also alerted the users of the breach. The only reason the public learned of this breach is because Facebook got caught.

In one embodiment of the present invention, a method for determining and displaying the security state of data is disclosed, the method having the steps of: providing a third party database operated by a third party having a computer storage medium configured for the storage of non-transitory data; storing data, from a first party, on the third party database; establishing, by the first party, a website interface accessible on the Internet to the data stored on the third party database; allowing access, by a second party, to the data stored on the third party database through the website interface of the first party; establishing a set of validation rules configured to be applied to the data, wherein compliance or non-compliance with the set of validation rules determines a security state of the data; evaluating whether the data is in compliance with the set of validation rules or whether the data is in non-compliance with the set of validation rules; determining the security state of the data based upon the compliance of the data with the set of validation rules; sending, by the third party, an indicator representative of the security state of the data to the website interface of the first party; and displaying the indicator to the second party on the website interface.

In other exemplary embodiments the data may be non-transitory data.

In other exemplary embodiments the present invention may include the step of evaluating whether the data is in compliance with the set of validation rules or whether the data is in non-compliance with the set of validation rules occurs each time when the data is created, updated, listed or deleted.

In other exemplary embodiments the present invention may include the step of confirming that a negative security state of the data has been resolved, and sending, by the third party, a new indicator representative of the new security state of the data to the website interface of the first party and displaying the new indicator to the second party on the website interface.

In other exemplary embodiments the first party may be a corporation.

In other exemplary embodiments the second party may be a website user.

In other exemplary embodiments the third party may not be affiliated with the first party.

In other exemplary embodiments the first party, second party and third party may not be affiliated with one another.

In other exemplary embodiments the first party, the second party and the third party may be located in different physical locations with respect to one another.

In other exemplary embodiments the present invention may include the step of restricting access to the data by the second party when the data is in non-compliance with the set of validation rules.

### BRIEF DESCRIPTION OF THE DRAWINGS

The accompanying drawings illustrate the invention. In such drawings:

FIG. 1 is a flow chart diagram of how data is accessed in prior art methods;

FIG. 2 is a flow chart diagram of how data is accessed in a method of the present invention;

FIG. 3 is a flow chart diagram of the third party communication interface of the present invention;

FIG. 4 is a flow chart diagram of the system validation of the present invention;

FIG. 5 is a flow chart diagram showing the Website Reporting Process steps of the present invention; and

FIG. 6 illustrates different indicia that may be used by the present invention to indicate the status of the information.

### DETAILED DESCRIPTION OF THE PREFERRED EMBODIMENTS

The present invention analyzes all information interactions and how the data was created, updated, listed or deleted based on a set of validation rules to ensure that the data is safe and not being tampered with. Should the rules be violated, the system will change the status of the record that will be sent to the third-party, which will be responsible for reporting the status to the public by changing the indicator and documenting the process of the violation. To the best of the inventor's knowledge, there is no third-party system that reports to the public the status verification and the validity of the data/information.

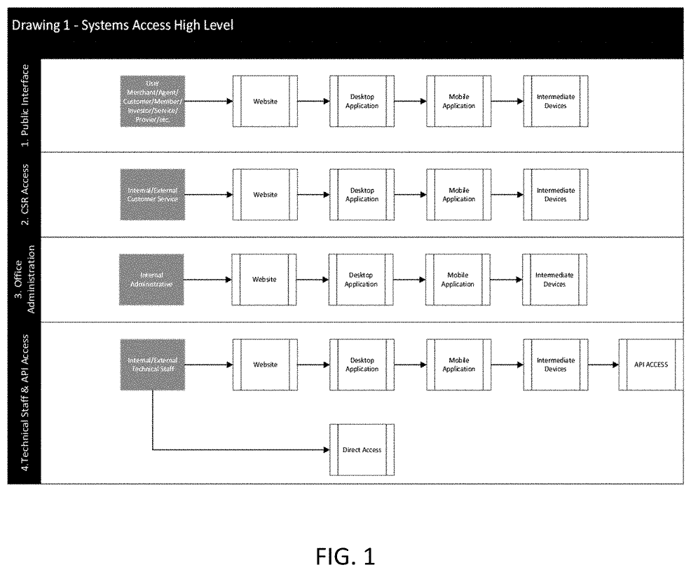

FIG. 1 is a flow chart depicting how data is accessed at the Systems Access High Level in a prior art system. There are four “swimming lanes” or rows (groups), being that of the Public Interface (customer), the CSR Access (Certificate Signing Request), the Office Administration (Administration Staff) and the Technical Staff and/or API Access. Each of these groups have access to the data through standard interfaces which can include websites, desktop computers/applications, mobile computers/applications or Intermediate Devices such as the Internet of Things that have wired or wireless access to the Internet or to an intranet. It is noted that group 4 also allows an API user to directly access the data as well.

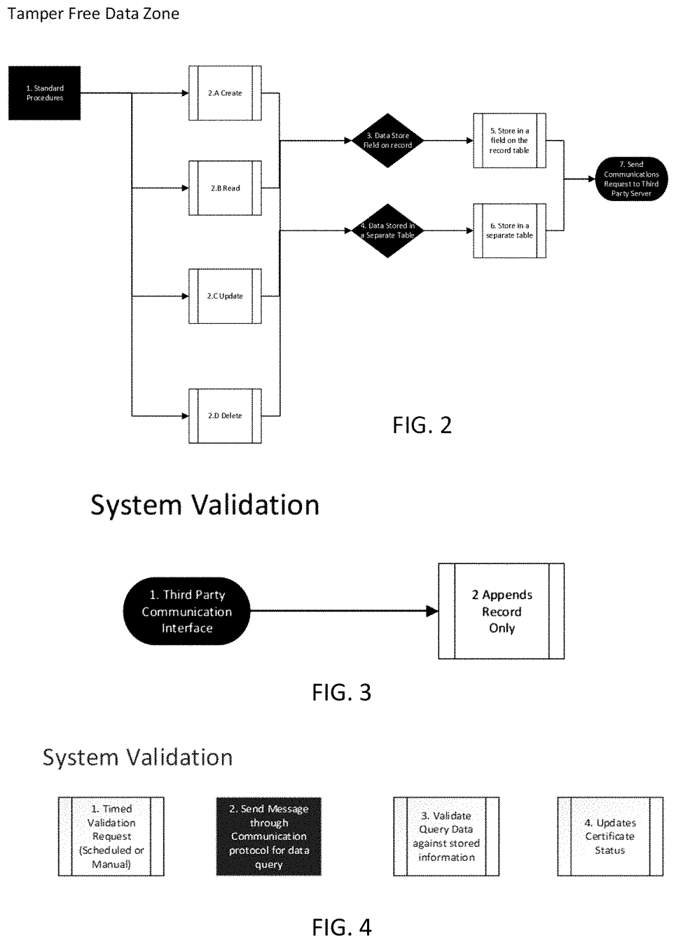

FIG. 2 is a flow chart of the present invention, depicting the system of a “Tamper Free Data Zone.” In the first step (Step 1) of the system, data is accessed in the same method/way as data is accessed today. Then, when any of the access methods are triggered (Steps 2A through 2D) the system will evaluate preset login to store data in a field (Step 3) and/or (Step 4) a designated location such as a separate table. The predefined variables will be stored in a field (Step 5) and or a (Step 6) table record or storage place holder that will be used later for matches and then (Step 7) send the message to the third part company.

FIG. 3 is a flow chart of showing the Third Party Communication Interface, in that a third party in (Step 1) can receive a message from the qualified source and then in (Step 2) the information is added. It is noted that the records are not allowed to be updated or deleted by any source.

FIG. 4 is a flow chart showing the System Validation. In (Step 1) the third-party external validation source will manually or automatically send a query to the originating source. In (Step 2) the originating source will send back the data requested where in (Step 3) a validation query will be run and in (Step 4) based on a pass/fail score the certificate will be updated.

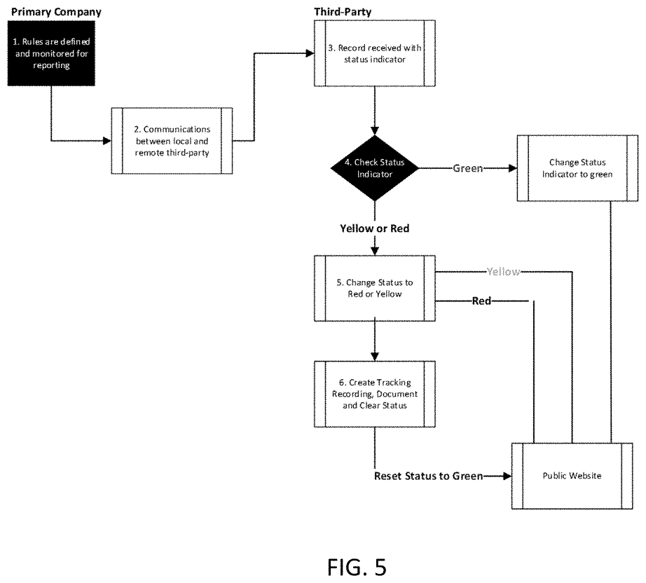

FIG. 5 is a flow chart showing the Website Reporting Process steps of the present invention.

(Step 1) Transactional data algorithms are triggered when records are modified, added to, edited or deleted. They are stored as a standard record and as an encrypted block chain record. When a specific rule is violated it changes the status from a green to a yellow or red indicator in the communication record.
(Step 2) The record is sent to the third party via a secure communication for storage as a read only block chain record.
(Step 3) When the third-party company receives a record, the status of the indicator for the “Tamper Free Data Zone” will change based on the “green”, “yellow’ or “red” (or other defined indicator).
(Step 4) If the status indicator is other than green, or another indicator that is considered acceptable based on predefined values, it will trigger a flag alert that will need to be addressed by any type of defined communications methods and create an internal block chain record.
(Step 5) The certification status will be updated on the website (Tamper Free Data Zone) based on the status with the highest indicator (red, yellow or green).
(Step 6) The third-party company will be responsible to collect and document why the event happened. Only when everyone is satisfied will the event be closed and the website status be returned to a green indicator when systems audits have been completed to ensure information is once again protected.

To help understand the present invention, the present is not the same as the previous prior art systems that are in use today, which are now discussed herein in more detail.

The present invention is not PCI compliance. PCI compliance is the standard that the Payment Card Industry has put in place to protect your credit card information. This standard allows for companies to fill out a form and state that they meet the standard. This is done annually and is only validated by a third party when you reach certain levels of transactions or if you have a breach of data. PCI Compliance has a monitoring factor that is supposed to be done to be incompliant. However, we do not know that it is actually being done.

The present invention is not HIPPA. HIPPA is for the guarding of medical information and that you are taking measures to protect the person's medical data from being accessed.

The present invention is not the Better Business Bureau where a consumer complains about a business and earns a rating based on how they respond and how many complaints they get. This is a method of rating that does nothing to protect the data or validate that you are taking care of the business.

The present invention is not the Secure Lock Indicator (Green or Dark Gray) that you see in the screen when you are browsing a website. These are great indicators that help you to feel confrontable. These Secure Lock Indicators have a time limit that is active as long as you pay for the renewal. However, it has nothing to do with the state of the actual data.

The present invention is not SOX Compliance. SOX Compliance merely means that the website operator is taking measures safeguarding the customer data.

The present invention is not just solutions that monitor systems and report to third parties for safe keeping for audits and reporting. The present invention is not any other know public reporting standard.

The present invention is a method of monitoring how your data is interacted with at all times that is then reported and stored in an encrypted chain stored locally and sent to a third party and then (Like the Secure Lock Indicator) lets the public know that your site is “actively” monitor by a third party and that your business adheres to standards that not only protects your data, it reports that they are responsive to issues when they arise. It also lets you, the public, know when you have been put at risk. It is a business process that hold companies accountable to you, the public, and gives the regulatory the assurance that the information is being reported with a level of integrity on the company website.

Today, technologies are constantly under attack by both internal and external sources. By having a third-party system that stores and does validation based on a series of rules, it will allow the public to know that they are in a “tamper free data zone” and that their information security is being monitored a third party. This will work much like a https security certificate where you will feel safe because you have a website indicator validated by a third party. It can also serve as a first stage indicator by auditors (Government, PCI compliance, HIPPA, SOC1, SOC2, SOX and other compliance standard) that there could be an issue with the data and how it is stored and or being processed.

When a site has the seal of approval, it indicates that the data has not been tampered with or unauthorized modifications. The third-party data validation company can support the validity of the information.

The present invention identifies if any mistakes have been made, as they could be due to poor programming or execution of an idea that exposes the company rather than internal or external manipulation. The present invention could also be used as a fraud tracking and reporting systems. The present invention has rule processes that can identify necessary changes before operation, to help with higher levels of security. The present invention could be used by any industry that is required to protect customer information provided.

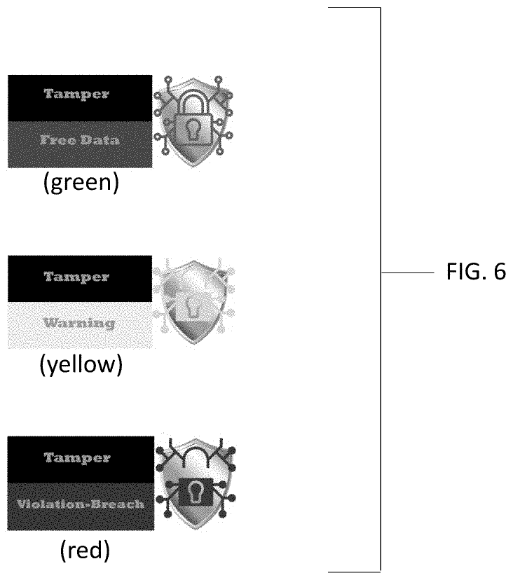

FIG. 6 is an embodiment of the indicators (visual indicia) that can be displayed to users that are accessing the information of the present invention. When data is tamper free as determined by the present invention, the indicator can include a block or shield, such as a green block, with words that the data is tamper free, or display a shield and/or lock that is closed. When the data might be compromised as determined by the present invention, the indicator can include a block or shield, such as a yellow block, with words that there is a warning, or display a lock that is partially opened to signify the breach of data. Finally, if data has been breached as determined by the present invention, the indicator can include a block or shield, such as a red block, with words that the data has been violated and/or breached, or display a lock or shield that is broken or damaged. As can be seen, there are many types of indicators that can be used to convey the various states of the data that has been analyzed by the present invention, as this teaching is not to be limited to the exact forms shown and described herein.

Throughout this application data and information have been discussed. This data/information may be considered a non-transitory data that is then stored on a computer storage medium.

What is claimed is:

1. A method for determining and displaying the security state of data, the method comprising the steps of:
providing a third party database operated by a third party having a computer storage medium configured for the storage of non-transitory data;
storing data, from a first party, on the third party database;
establishing, by the first party, a website interface accessible on the Internet to the data stored on the third party database;
allowing access, by a second party, to the data stored on the third party database through the website interface of the first party;
establishing a set of validation rules configured to be applied to the data, wherein compliance or non-compliance with the set of validation rules determines a security state of the data;
evaluating whether the data is in compliance with the set of validation rules or whether the data is in non-compliance with the set of validation rules;
determining the security state of the data based upon the compliance of the data with the set of validation rules;
sending, by the third party, an indicator representative of the security state of the data to the website interface of the first party; and
displaying the indicator to the second party on the website interface.

2. The method of claim 1, wherein the data is non-transitory data.

3. The method of claim 1, wherein the step of evaluating whether the data is in compliance with the set of validation rules or whether the data is in non-compliance with the set of validation rules occurs each time when the data is created, updated, listed or deleted.

4. The method of claim 1, including the step of confirming that a negative security state of the data has been resolved, and sending, by the third party, a new indicator representative of the new security state of the data to the website interface of the first party and displaying the new indicator to the second party on the website interface.

5. The method of claim 1, wherein the first party is a corporation.

6. The method of claim 1, wherein the second party is a website user.

7. The method of claim 1, wherein the third party is not affiliated with the first party.

8. The method of claim 1, wherein the first party, the second party and the third party are not affiliated with one another.

9. The method of claim 1, wherein the first party, the second party and the third party are located in different physical locations with respect to one another.

10. The method of claim 1, including the step of restricting access to the data by the second party when the data is in non-compliance with the set of validation rules.

11. A method for determining and displaying the security state of data, the data being non-transitory data, the method comprising the steps of:
providing a third party database operated by a third party having a computer storage medium configured for the storage of non-transitory data;
storing data, from a first party, on the third party database;
establishing, by the first party, a website interface accessible on the Internet to the data stored on the third party database;
allowing access, by a website user, to the data stored on the third party database through the website interface of the first party;
establishing a set of validation rules configured to be applied to the data, wherein compliance or non-compliance with the set of validation rules determines a security state of the data;
evaluating whether the data is in compliance with the set of validation rules or whether the data is in non-compliance with the set of validation rules;
determining the security state of the data based upon the compliance of the data with the set of validation rules;
sending, by the third party, an indicator representative of the security state of the data to the website interface of the first party; and
displaying the indicator to the website user on the website interface;
wherein the step of evaluating whether the data is in compliance with the set of validation rules or whether the data is in non-compliance with the set of validation rules occurs each time when the data is created, updated, listed or deleted;
wherein the first party, the website user and the third party are not affiliated with one another; and
wherein the first party, the website user and the third party are located in different physical locations with respect \to one another.

12. The method of claim 11, including the step of confirming that a negative security state of the data has been resolved, and sending, by the third party, a new indicator representative of the new security state of the data to the website interface of the first party and displaying the new indicator to the website user on the website interface.
